(19) United States
(12) Patent Application Publication
(10) Pub. No.: US 2008/0245747 A1
(43) Pub. Date: Oct. 9, 2008

(54) METHODS OF DEGASSING OPHTHALMIC LENS MONOMER MIXTURES

(76) Inventors: Edward R. Kernick, Jacksonville, FL (US); Hamid Anthony Darabi, St. Augustine, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/050,215

(22) Filed: Mar. 18, 2008

Related U.S. Application Data
(60) Provisional application No. 60/910,473, filed on Apr. 6, 2007.

(51) Int. Cl. B01D 19/04

(52) U.S. Cl. 210/750

(57) ABSTRACT

Methods of degassing silicone hydrogel lens formulations are disclosed herein.

### RELATED APPLICATIONS

This application is a non-provisional filing of U.S. Pat. App. Ser. No. 60/910,473, filed on Apr. 6, 2007.

This invention relates to the production of ophthalmic lenses, particularly lenses made from silicone hydrogel formulations

### BACKGROUND

Ophthalmic lenses, particularly soft contact lenses are made from mixtures of monomers that are polymerized to for a hard substance that may be swelled with water. Initially ophthalmic lenses were made from hydrogel formulations that did not contain silicone. Recent advances have lead to hydrogels that contain silicone monomers and macromers. Ophthalmic lenses made from these materials are extremely popular due their high oxygen permeability and other factors. However, the production of these materials is different from the production of hydrogels without silicone.

The formulations that are polymerized to form silicone hydrogels must be degassed prior to polymerization. If these materials are not degassed the lenses that produced contain a number of chips holes, bubble and tears. To avoid this problem, silicone hydrogel formulations are often degassed using a variety of techniques (rotary evaporators, nitrogen purging and the like) that are not incorporated into the manufacturing line. It would be most beneficial if the method of degassing silicone hydrogel formulations could be incorporated into a manufacturing line. This is a problem that silicone hydrogels share with non-silicone containing hydrogels. U.S. Pat. No. 5,435,943, which is hereby incorporated by reference in its entirety, addresses this problem for non-silicone containing hydrogels. This degasser is incorporated into the manufacturing line and adequately reduces dissolved gases in non-silicone containing hydrogels. However, the degasser of this patent does not work well for silicone hydrogels. Therefore it would be useful to find a degasser that may be incorporated into a production line and that degasses silicone hydrogels silicone hydrogels. The following invention addresses this need.

### DETAILED DESCRIPTION OF THE INVENTION

This invention includes a method of degassing liquid monomer formulation comprising treating said formulation with a radial liquid flow path degasser.

As used herein, “liquid monomer formulation” refers the mixture of components that are used to form ophthalmic lenses, such as soft contact lenses, intraocular lenses, overlay lenses, ocular inserts, punctual plugs, and optical inserts. The preferred liquid monomer formulations of the invention as those silicone elastomers, hydrogels, silicone hydrogels, and fluorohydrogels used to prepare soft contact lenses. Soft contact lens formulations are disclosed in U.S. Pat. No. 5,710,302, WO 9421698, EP 406161, JP 2000016905, U.S. Pat. No. 5,998,498, U.S. Pat. No. 6,087,415, U.S. Pat. No. 5,760,100, U.S. Pat. No. 5,776,999, U.S. Pat. No. 5,789,461, U.S. Pat. No. 5,849,811, and U.S. Pat. No. 5,965,631. The foregoing references are hereby incorporated by reference in their entirety. The particularly preferred liquid monomer formulations are those used to prepare soft contact lenses known by the United States Approved Names of acofilcon A, alofilcon A, alphafilcon A, amifilcon A, astifilcon A, atalafilcon A, balafilcon A, bisfilcon A, bufilcon A, comfilcon, crofilcon A, cyclofilcon A, darfilcon A, deltafilcon A, deltafilcon B, dimefilcon A, drooxifilcon A, epsifilcon A, esterifilcon A, etafilcon A, focofilcon A, galyfilcon A, genfilcon A, govafilcon A, hefilcon A, hefilcon B, hefilcon D, hilafilcon A, hilafilcon B, hioxifilcon B, hioxifilcon C, hixoifilcon A, hydrofilcon A, lenefilcon A, licryfilcon A, licryfilcon B, lidofilcon A, lidofilcon B, lotrafilcon A, lotrafilcon B, mafilcon A, mesifilcon A, methafilcon B, mipafilcon A, nelfilcon A, netrafilcon A, ocufilcon A, ocufilcon B, ocufilcon C, ocufilcon D, ocufilcon E, ofilcon A, omafilcon A, oxyfilcon A, pentafilcon A, perfilcon A, pevafilcon A, phemfilcon A, polymacon, senofilcon A, silafilcon A, siloxyfilcon A, tefilcon A, tetrafilcon A, trifilcon A, vasurfilcon, vifilcon, and xylofilcon A. More particularly preferred ophthalmic devices of the invention are galyfilcon A, senofilcon A, genfilcon A, lenefilcon A, comfilcon, lotrafilcon A, lotrafilcon B, and balafilcon A. More preferred lenses include comfilcon, galyfilcon A, and senofilcon A. The most preferred lenses include galyfilcon A, and senofilcon A.

The term “radial liquid flow path degasser” refers to a device that allows liquids containing gases to flow across a hollow membrane. The hollow membrane removes dissolved gases from the liquid. The preferred radial liquid flow path degassers are 2×6 Radial Flow SuperPhobic (see http://wwww.liqui-cel.com/uploads/documents/D82 Rev9 8-07 2×6%20SP%20Radial%20Flow3.pdf) and Liqui-Cel 6×28 NB™, manufactured by Liqui-Cel®, the particularly preferred radial degasser is the 2×6 Radial Flow SuperPhobic.

As used herein “treating” means physical methods of contacting the liquid monomer mixture with the radial liquid flow path degasser. The ophthalmic devices may be treated with the anti-allergic agent anytime after they are polymerized. Automated processes to prepare contact lenses include the steps of polymerizing the liquid monomer formulations to form a disc, using two mold halves, spincasted, or static casted and polymerized. See, U.S. Pat. Nos. 4,495,313; 4,680,336; 4,889,664, 3,408.429; 3,660,545; 4,113,224; and 4,197,266, all of which are incorporated by reference in their entirety. Any of these steps are typically followed by removal from the molding surface, hydration, inspection, and packaging. The methods of the invention are particularly useful because they can be incorporated directly into the manufacturing line saving time and wasted monomer material.

The aforementioned methods of the invention are meant to illustrate the invention and suggest methods and devices that embody the invention. Those knowledgeable in the production soft contact lenses as well as other specialties may find other methods of practicing the invention. However, those methods are deemed to be within the scope of this invention.

What is claimed is:

1. A method of degassing liquid monomer formulation comprising treating said formulation with a radial liquid flow path degasser.

2. The method of claim 1 wherein the liquid monomer formulation is comprises silicone.

3. The method of claim 1 wherein the liquid monomer formulation is selected from the group consisting of formulations of acofilcon A, alofilcon A, alphafilcon A, amifilcon A, astifilcon A, atalafilcon A, balafilcon A, bisfilcon A, bufilcon A, comfilcon, crofilcon A, cyclofilcon A, darfilcon A, deltafilcon A, deltafilcon B, dimefilcon A, drooxifilcon A, epsifilcon A, esterifilcon A, etafilcon A, focofilcon A, galyfilcon A, genfilcon A, govafilcon A, hefilcon A, hefilcon B, hefilcon D, hilafilcon A, hilafilcon B, hioxifilcon B, hioxifilcon C, hixoifilcon A, hydrofilcon A, lenefilcon A, licryfilcon A, licryfilcon B, lidofilcon A, lidofilcon B, lotrafilcon A, lotrafilcon B, mafilcon A, mesifilcon A, methafilcon B, mipafilcon A, nelfilcon A, netrafilcon A, ocufilcon A, ocufilcon B, ocufilcon C, ocufilcon D, ocufilcon E, ofilcon A, omafilcon A, oxyfilcon A, pentafilcon A, perfilcon A, pevafilcon A, phemfilcon A, polymacon, senofilcon A, silafilcon A, siloxyfilcon A, tefilcon A, tetrafilcon A, trifilcon A, vasurfilcon, vifilcon, and xylofilcon A.

7. The method of claim 1 wherein the liquid monomer formulation is selected from the group consisting formulation of galyfilcon A, senofilcon A, genfilcon A, lenefilcon A, comfilcon, lotrafilcon A, lotrafilcon B, and balafilcon A.

8. The method of claim 1 wherein the ophthalmic device is selected from the group consisting of comfilcon, etafilcon A, galyfilcon A, and senofilcon A.

9. The method of claim 1 wherein the radial liquid flow path degasser is a Liqui-Cel 6×28NB.

10. The method of claim 1 wherein said degassing is conducted as part of an automatic soft contact lens production line.
